(19) United States
(12) Patent Application Publication
(10) Pub. No.: US 2017/0327386 A1
(43) Pub. Date: Nov. 16, 2017

(54) WATER PURIFYING MACHINE COMPONENT AND CONTROL METHOD THEREFOR

(71) Applicants: FOSHAN VIOMI ELECTRICAL TECHNOLOGY CO., LTD., Guangdong (CN); XIAOMI INC., Beijing (CN)

(72) Inventors: Xiaoping CHEN, Guangdong (CN); Xinyu LIU, Guangdong (CN)

(21) Appl. No.: 15/531,468

(22) PCT Filed: Oct. 26, 2015
(86) PCT No.: PCT/CN2015/092789

§ 371 Date: May 30, 2017

(30) Foreign Application Priority Data
Dec. 3, 2014 (CN) 201410719342.9

(51) Int. Cl. C02F 1/00; B01D 37/04

(52) U.S. Cl. CPC C02F 1/008; B01D 37/048; C02F 1/003; B01D 37/043; C02F 2209/02; C02F 2209/40; C02F 2307/06; C02F 2201/005

(57) ABSTRACT

The present invention relates to a water purifying machine component and a control method thereof, wherein the water purifying machine component comprises a flow divider body and a water purifier body which are connected by a calandria tube, wherein the flow divider body is provided with a first electric control device, an external water inlet, a purified water inlet, a tap water outlet, a tap water discharging port, a purified water discharging port and a first electric component, the external water inlet is connected with the tap water outlet, and the inner end of the purified water inlet is connected with the purified water discharging port; the water purifier body is provided with a second electric control device, a purified water outlet, a tap water inlet and a second electric component; and the first electric control device and the second electric control device are electrically connected. A circuit of a flow divider and a circuit of a water purifier, and a water path of the flow divider and a water path of the water purifier are in mutual communication with each other, so that the flow divider may control the water purifier to execute related actions, meanwhile, the circuits and the water paths which are connected with the flow divider and the water purifier are arranged in the calandria tube, so that the circuits and the water paths are very regular.

### BACKGROUND OF THE INVENTION

The present invention relates to a water purifying machine component and a control method thereof.

Currently, there are more and more desktop water purifiers, generally, this product and tap water are directly connected through a faucet. The faucet is connected with the water purifier, and the flow divider selection switch is used to select tap water or purified water; generally, this switch is a manual mechanical switch.

Since the switch is the manual mechanical switch, it is difficult to control the water purifier in order to realize automatic control or remote control, especially when the water purifier is abnormal, it is difficult to achieve automatic pressure relief or start, which may cause excessive pressure on a pipeline or other unforeseen abnormalities.

### BRIEF SUMMARY OF THE INVENTION

The present invention aims at overcoming above-mentioned deficiencies in the prior art and providing a water purifier component and a control method thereof, the water purifier component is reasonably structured and automatically controls tap water or purified water to flow by means of the combination of an electronic control device and an electric element.

The object of the utility mode is realized by the followings:

A water purifying machine component comprises a flow divider body and a water purifier body which are connected by a calandria tube; wherein the flow divider body is provided with a first electric control device, an external water inlet, a purified water inlet, a tap water outlet, a tap water discharging port, a purified water discharging port and a first electric component, the external water in Set is connected with the tap water outlet, and the inner end of the purified water inlet is connected with the purified water discharging port; the water purifier body is provided with a second electric control device, a purified water outlet, a tap water inlet and a second electric component; the calandria tube at least comprises a tap water pipeline, a purified water pipeline and a wire pipeline therein, two ends of the tap water pipeline are connected with the tap water outlet and the tap water inlet, respectively, two ends of the purified water pipeline are connected with the outer end of the purified water inlet and the purified water outlet, respectively, the wire pipeline is provided with a wire therein, the first electric control device and the second electric control device are electrically connected via the wire; the first electric component and the second electric component are electrically connected with the first electric control device and/or the second electric control device, respectively.

The object of the present invention can still be solved with the following solutions:

As a more specific solution, the first electric component comprises a water flow sensor for sensing whether a water source enters the external water inlet, the water flow sensor is provided in the external water inlet and electrically connected with the first electric control device.

The first electric component still comprises a normally opened type solenoid valve, the normally opened solenoid valve is connected with the external water inlet and the tap water discharging port therebetween, and electrically connected with the first electric control device.

The flow divider body is still provided with a flow dividing pipe, the flow dividing pipe is a T-branch pipe, each end of which is connected with the external water inlet, the tap water outlet and the normally opened type solenoid valve, respectively.

The second electric component comprises a normally close type solenoid valve and a booster pump, the normally close type solenoid valve is provided on the tap water inlet; the normally close type solenoid valve and the booster pump are electrically connected with the second electric control device, respectively.

The first electric component still comprises a temperature sensor for sensing the temperature of the water source entering the external water inlet, the temperature sensor is provided inside or outside the external water inlet and electrically connected with the first electric control device and/or the second electric control device.

A control method of a water purifying machine component wherein when a water flow sensor detects that water enters an external water inlet, the water flow sensor sends a detected signal to a first electric control device of a flow divider body, meanwhile, the first electric control device communicates with a second electric control device of a water purifier body, the first electric control device controls a normally opened type solenoid valve of the flow divider body to execute corresponding actions, the second electric control device controls a normally close type solenoid valve and a booster pump of the water purifier body to execute corresponding actions.

When the normally opened solenoid valve is under an open state, the normally close type solenoid valve is under a close state; when the normally opened solenoid valve is under a close state, the normally close type solenoid valve is under an open state.

A temperature sensor for sensing the temperature of a water source entering the external water inlet is still provided at the external water inlet of the flow divider body, the temperature sensor is electrically connected with the first electric control device and/or the second electric control device, when the temperature sensor detects that the temperature exceeds 40° C., the temperature sensor controls the normally close type solenoid valve to close.

When the water flow sensor senses that the water enters the external water inlet, the second electric control device opens the booster pump according to a set time, if the water flow sensor does not sense flowing water, the water flow sensor does not start the booster pump to produce purified water regardless of any state .

The present invention has the following effects:

A circuit of a flow divider and a circuit of a water purifier, and a water path of the flow divider and a water path of the water purifier are in mutual communication with each other, so that the flow divider may control the water purifier to execute related actions, meanwhile, the circuits and the water paths which are connected with the flow divider and the water purifier are arranged in the calandria tube, so that the circuits and the water paths are very regular.

(2) A water flow sensor for sensing whether a water source enters an external water inlet is still provided on the flow divider of the present invention, the opening of the booster pump is directly related to a signal of the water flow sensor, if the water flow sensor senses that water enters, the water flow sensor opens the booster pump according to requirements of programs and a set time, if the water flow sensor does not sense flowing water, the water flow sensor does not start the booster pump to produce purified water regardless of any state, so as to protect the booster pump when there is no water;

(3) As a filter element of a filtering device in the water purifier is greater impacted by temperature, generally when water temperature exceeds 40° C. the temperature damages the filter element, therefore, the flow divider is still provided with a temperature sensor for sensing the temperature of the water source entering the external water inlet, for example, when the water temperature exceeds the defined temperature value, a control device commands an executing element on the water purifier to operate according to the programs, for example, a valve of the water purifier is closed so that hot water flows out from a tap water discharging port of the flow divider, however, this water will not enter the water purifier to protect the filtering element;

(4) The calandria tube is provided with a tap water pipeline and a purified water pipeline, the tap water enters the water purifier via the tap water pipeline, the water filtered through the water purifier passes through the purified water pipeline and returns back to and flows out of the flow divider, thus having convenient connection.

### BRIEF DESCRIPTION OF THE DRAWINGS

FIG. 1 is a schematic structural view of an example of the present invention.

FIG. 2 is a schematic structural view of a flow divider body of the present invention.

FIG. 3 is a schematic structural view that a flow divider body passing through a connection structure of a clamp and a calandria tube.

FIG. 4 is a schematic structural view of the opening state of a clamp.

FIG. 5 is a schematic structural view of the fastening state of a clamp,

FIG. 6 is a schematic structural view of a calandria tube.

### DETAILED DESCRIPTION OF THE INVENTION

The present invention is further described with the combination of the drawings and examples:

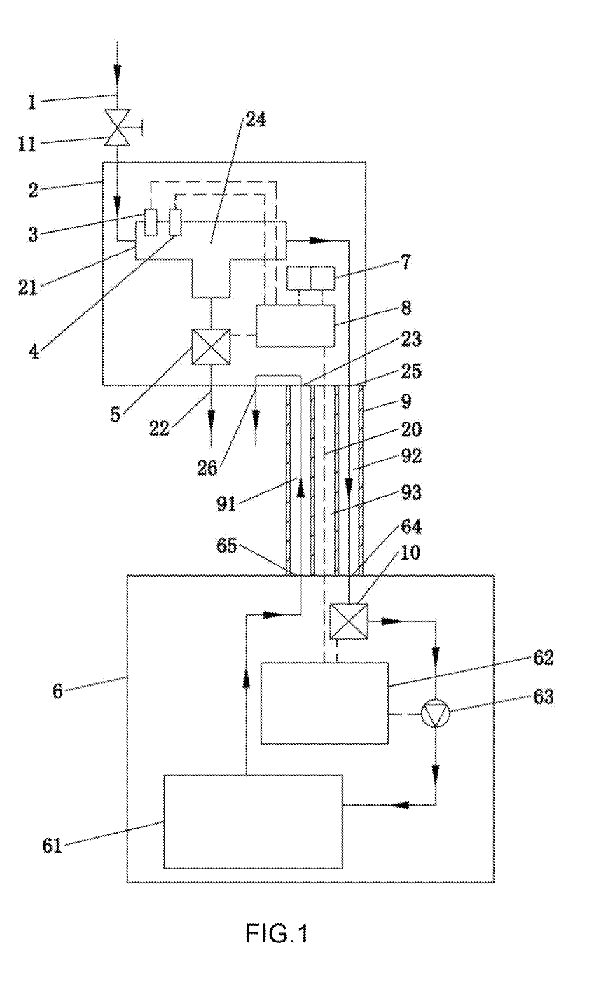

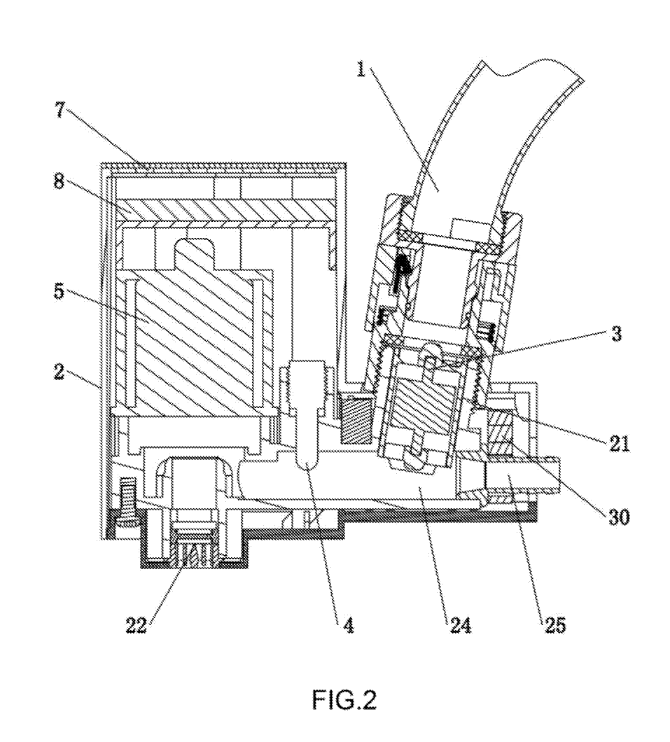

As shown in FIG. 1, a water purifying machine component 9 comprises a flow divider body 2 and a water purifier body 8 which are connected by a calandria tube; wherein the flow divider body 2 is provided with a first electric control device 8, an external water inlet 21 a purified water inlet 23, a tap water outlet 25, a tap water discharging port 22, a purified water discharging port 26 and a first electric component, the external water inlet 21 is connected with the tap water outlet 25, and the inner end of the purified water inlet 23 is connected with the purified water discharging port 26; the water purifier body 8 is provided with a second electric control device 62, a purified water outlet 65, a tap water inlet 64 and a second electric component; the calandria tube 9 at least comprises a tap water pipeline 92, a purified water pipeline 91 and a wire pipeline 93 therein, two ends of the tap water pipeline 92 are connected with the tap water outlet 25 and the tap water inlet 84, respectively, two ends of the purified water pipeline 91 are connected with the outer end of the purified water inlet 23 and the purified water outlet 65, respectively, the wire pipeline 93 is provided with a wire 20 therein, and the first electric control device 8 and the second electric control device 82 are electrically connected via the wire 20; the first electric component and the second electric component are electrically connected with the first electric control device 8 and/or the second electric control device 62, respectively.

The first electric component comprises a water flow sensor 3 for sensing whether a water source enters the external water inlet 21, the water flow sensor 3 is provided in the external water inlet 21 and electrically connected with the first electric control device 8.

The first electric component still comprises a normally opened type solenoid valve 5, the normally opened solenoid valve 5 is connected with the external water inlet 21 and the tap water discharging port 22 therebetween, and electrically connected with the first electric control device 8.

The flow divider body 2 is still provided with a flow dividing pipe 24, the flow dividing pipe 24 is a T-branch pipe, each end of which is connected with the external water inlet 21, the tap water outlet 25 and the normally opened type solenoid valve 5, respectively.

The second electric component comprises a normally close type solenoid valve 10 and a booster pump 63, the normally close type solenoid valve 10 is provided on the tap water inlet 64; the normally close type solenoid valve 10 and the booster pump 63 are electrically connected with the second electric control device 82, respectively.

The first electric component still comprises a temperature sensor 4 for sensing the temperature of the water source entering the external water inlet 21, the temperature sensor 4 is provided inside or outside the external water inlet 21 and electrically connected with the first electric control device 8 and/or the second electric control device 62.

Above flow divider body 2 is provided with a control panel 7, the control panel 7 is electrically connected with the first electric control device 8, the external water inlet 21 is connected with the faucet 1, the faucet 1 is provided with an on-off valve 11. The dotted line in FIG. 1 represents an electrical connection line.

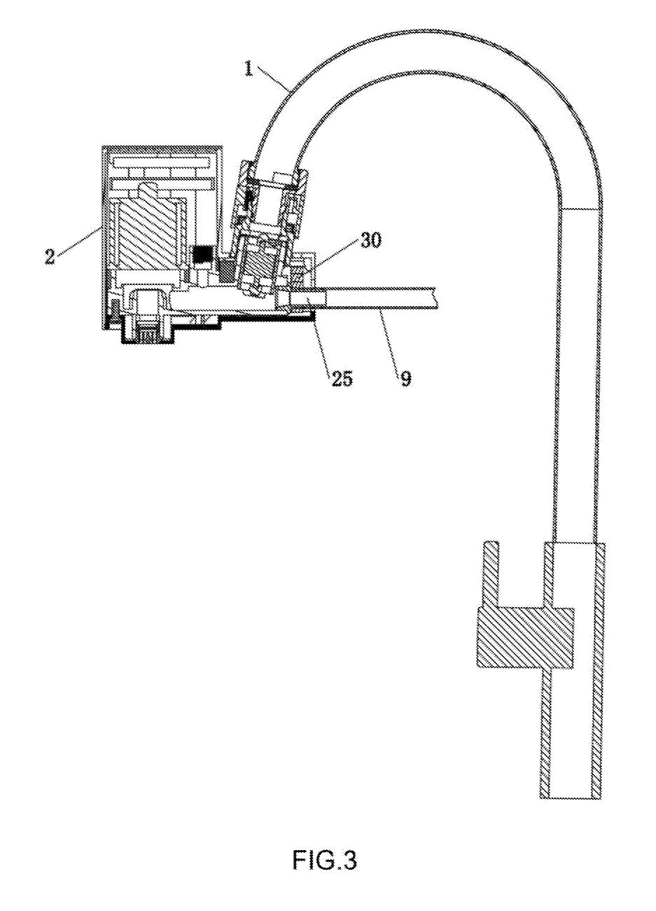

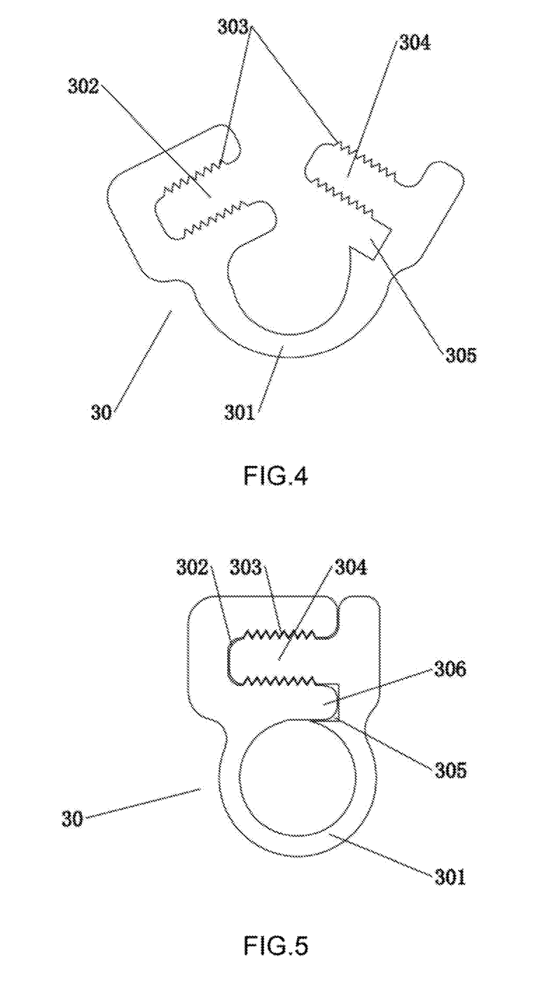

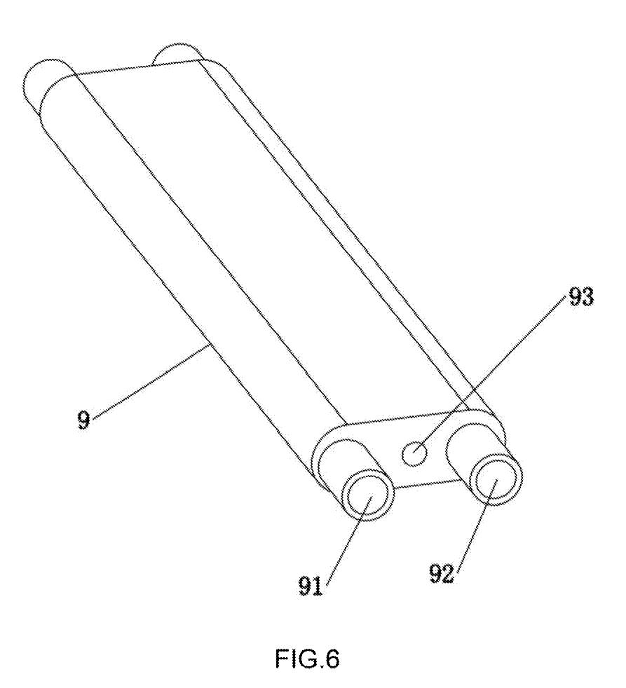

As shown with combination of FIGS. 3-6, a port of the tap water pipeline 92 of the calandria tube 9 and a port of the purified water pipeline 91 are compacted, sealed and fixedly connected with the peripheries of the tap water outlet 25 and the purified water inlet 23 via a clamp 30, respectively, the clamp 30 comprises an open loop-shaped tape 301, two ends of the tape 301 are inserted into and matched with each other, a fastening matching surface 303 is still provided at an insertion and matching place.

Two ends of the tape 301 are provided with a U-shaped connector 302 and a T-shaped connector 304, respectively, the U-shaped connector 302 and the T-shaped connector 304 are inserted into and matched with each other.

The fastening matching surface 303 is a tooth surface, the tooth surface is provided with an inner wall of a U-shaped joint 302 and an outer wall of a T-shaped joint 304, respectively. Teeth of the tooth surface are acute-angle triangles. Of course, the teeth of the tooth surface may also be right-angle triangles, moreover, a vertical right-angle surface of the right-angled triangle more has an ants-retraction role.

A clamping groove 305 is provided at a connection place of the T-shaped joint 304 and the tape 301, after the T-shaped joint 304 and the T-shaped joint 304 are inserted into and matched with each other, one end of the U-shaped joint 302 is received on the clamping groove 305.

A control method of a water purifying machine component, wherein when a water flow sensor 3 detects that water enters an external water inlet 21, the water flow sensor 3 sends a detected signal to a first electric control device 8 of a flow divider body 2, meanwhile, the first electric control device 8 communicates with a second electric control device 82 of a water purifier body 8, the first electric control device 8 controls a normally opened type solenoid valve 5 of the flow divider body 2 to execute corresponding actions, the second electric control device 62 controls a normally close type solenoid valve 10 and a booster pump 63 of the water purifier body 6 to execute corresponding actions.

When the normally opened solenoid valve 5 is under an open state, the normally close type solenoid valve 10 is under a close state; when the normally opened solenoid valve 5 is under a close state, the normally close type solenoid valve 10 is under an open state.

A temperature sensor 4 for sensing the temperature of a water source entering the external water inlet 21 is still provided at the external water inlet 21 of the flow divider body 2, the temperature sensor 4 is electrically connected with the first electric control device 8 and/or the second electric control device 62, when the temperature sensor 4 detects that the temperature exceeds a defined temperature value, the temperature sensor 4 controls the normally close type solenoid valve 10 to close. Meanwhile, the normally opened solenoid valve 5 is opened so that hot water flows from the tap water discharging port 22 of a flow divider so as not to enter the filtering device 61 of the water purifier body 8 to cause damage to the filtering device 61 above defined temperature value is set based on the heat resistance level of a filter element of the water purifying machine, for example, when water temperature exceeds 40° C., the filter element has a risk of damage will be damaged, then the defined temperature should be set to be 40° C.

When the water flow sensor 3 senses that the water enters the external water inlet 21, the second electric control device 62 opens the booster pump 63 according to a set time, if the water flow sensor 3 does not sense the flowing water, the water flow sensor 3 does not start the booster pump 63 to produce purified water regardless of any state.

1. A water purifying machine component comprising a flow divider body (2) and a water purifier body (6) which are connected by a calandria tube (9); wherein the flow divider body (2) is provided with a first electric control device (8), an external water inlet (21), a purified water inlet (23), a tap water outlet (25), a tap water discharging port (22), a purified water discharging port (26) and a first electric component; the external water inlet (21) is connected with the tap water outlet (25), and the inner end of the purified water inlet (23) is connected with the purified water discharging port (26);
the water purifier body (6) is provided with a second electric control device (62), a purified water outlet (65), a tap water inlet (64) and a second electric component;
the calandria tube (9) at least comprises a tap water pipeline (92), a purified water pipeline (91) and a wire pipeline (93) therein, two ends of the tap water pipeline (92) are connected with the tap water outlet (25) and the tap water inlet (64), respectively, two ends of the purified water pipeline (91) are connected with the outer end of the purified water inlet (23) and the purified water outlet (65), respectively, the wire pipeline (93) is provided with a wire (20) therein, and the first electric control device (8) and the second electric control device (62) are electrically connected via the wire (20);
the first electric component and the second electric component are electrically connected with the first electric control device (8) and/or the second electric control device (62), respectively.

2. The water purifying machine component according to claim 1, wherein the first electric component comprises a water How sensor (3) for sensing whether a water source enters the external water inlet (21), the water flow sensor (3) is provided in the external water inlet (21) and electrically connected with the first electric control device (8).

3. The water purifying machine component according to claim 2, wherein the first electric component still comprises a normally opened type solenoid valve (5), the normally opened solenoid valve (5) is connected with the external water inlet (21) and the tap water discharging port (22) therebetween, and electrically connected with the first electric control device (8).

4. The water purifying machine component according to claim 3, wherein the flow divider body (2) is still provided with a flow dividing pipe (24), the flow dividing pipe (24) is a T-branch pipe, each end of which is connected with the external water inlet (21), the tap water outlet (25) and the normally opened type solenoid valve (5), respectively.

5. The water purifying machine component according to claim 3, wherein the second electric component comprises a normally close type solenoid valve (10) and a booster pump (63), the normally close type solenoid valve (10) is provided on the tap water inlet (64); the normally close type solenoid valve (10) and the booster pump (63) are electrically connected with the second electric control device (62), respectively.

6. The water purifying machine component according to claim 5, wherein the first electric component still comprises a temperature sensor (4) for sensing the temperature of the water source entering the external water inlet (21), the temperature sensor (4) is provided inside or outside the external water inlet (21) and electrically connected with the first electric control device (8) and/or the second electric control device (62), respectively.

7. A control method of a water purifying machine component according to claim 5, wherein when a water flow sensor (3) detects that water enters an external water inlet (21), the water flow sensor (3) sends a detected signal to a first electric control device (8) of a flow divider body (2). meanwhile, the first electric control device (8) communicates with a second electric control device (62) of a water purifier body (6), the first electric control device (8) controls a normally opened type solenoid valve (5) of the flow divider body (2) to execute corresponding actions, the second electric control device (62) controls a normally close type solenoid valve (10) and a booster pump (63) of the water purifier body (6) to execute corresponding actions.

8. The control method of the water purifying machine component according to claim 7, wherein when the normally opened solenoid valve (5) is under an open state, the normally close type solenoid valve (10) is under a dose state; when the normally opened solenoid valve (5) is under a close state, the normally close type solenoid valve (10) is under an open state.

9. The control method of the water purifying machine component according to claim 7, wherein a temperature sensor (4) for sensing the temperature of a water source entering the external water inlet (21) is still provided at the external water inlet (21) of the flow divider body (2), the temperature sensor (4) is electrically connected with the first electric control device (8) and/or the second electric control device (62); when the temperature sensor (4) detects that the temperature exceeds a defined temperature value, the temperature sensor (4) controls the normally close type solenoid valve (10) to close.

10. The control method of the water purifying machine component according to claim 7, wherein when the water flow sensor (3) senses that the water enters the external water inlet (21), the second electric control device (62) opens the booster pump (63) according to a set time, if the water flow sensor (3) does not sense flowing water, the water flow sensor (3) does not start the booster pump (63) to produce purified water regardless of any state.

11. The water purifying machine component according to claim 4, wherein the second electric component comprises a normally close type solenoid valve (10) and a booster pump (63), the normally close type solenoid valve (10) is provided on the tap water inlet (64); the normally close type solenoid valve (10) and the booster pump (83) are electrically connected with the second electric control device (62), respectively.

12. The water purifying machine component according to claim 11 wherein the first electric component still comprises a temperature sensor (4) for sensing the temperature of the water source entering the external water inlet (21), the temperature sensor (4) is provided inside or outside the external water inlet (21) and electrically connected with the first electric control device (8) and/or the second electric control device (62), respectively.

13. A control method of a water purifying machine component according to claim 12, wherein when a water flow sensor (3) detects that water enters an external water inlet (21), the water flow sensor (3) sands a detected signal to a first electric control device (8) of a flow divider body (2), meanwhile, the first electric control device (8) communicates with a second electric control device (62) of a water purifier body (6), the first electric control device (8) controls a normally opened type solenoid valve (5) of the flow divider body (2) to execute corresponding actions, the second electric control device (62) controls a normally close type solenoid valve (10) and a booster pump (63) of the water purifier body (6) to execute corresponding actions.

14. The control method of the water purifying machine component according to claim 13, wherein when the normally opened solenoid valve (5) is under an open state, the normally close type solenoid valve (10) is under a close state: when the normally opened solenoid valve (5) is under a close state, the normally close type solenoid valve (10) is under an open state.

15. The control method of the water purifying machine component according to claim 13, wherein a temperature sensor (4) for sensing the temperature of a water source entering the external water inlet (21) is still provided at the external water inlet (21) of the flow divider body (2), the temperature sensor (4) is electrically connected with the first electric control device (8) and/or the second electric control device (62); when the temperature sensor (4) detects that the temperature exceeds a defined temperature value, the temperature sensor (4) controls the normally close type solenoid valve (10) to close.

16. The control method of the water purifying machine component according to claim 13, wherein when the water flow sensor (3) senses that the water enters the external water inlet (21), the second electric control device (62) opens the booster pump (63) according to a set time, if the water flow sensor (3) does nor sense flowing water, the water flow sensor (3) does not start the booster pump (63) to produce purified water regardless of any stats.
